(19) United States
(12) Patent Application Publication
(10) Pub. No.: US 2016/0282939 A1
(43) Pub. Date: Sep. 29, 2016

(54) Brain-Computer Interface

(71) Applicant: DANMARKS TEKNISKE UNIVERSITET, Kgs. Lyngby (DK)

(72) Inventors: Helge B.D. SØRENSEN, Græsted (DK); Sadasivan PUTHUSSERYPADY, Birkerød (DK); Adnan VILIC, Taastrup (DK); Troels Wessenberg kJÆR, Birkerød (DK); Carsten Eckhart THOMSEN, Haslev (DK)

(73) Assignee: DANMARKS TEKNISKE UNIVERSITET, Kgs. Lyngby (DK)

(21) Appl. No.: 14/901,441

(22) PCT Filed: Jun. 25, 2014
(86) PCT No.: PCT/EP2014/063328

§ 371 Date: Dec. 28, 2015

(30) Foreign Application Priority Data
Jun. 28, 2013 (EP) 13174262.9

(51) Int. Cl. G06F 3/01; G06F 3/0482

(52) U.S. Cl. CPC G06F 3/015; G06F 3/0482

(57) ABSTRACT

A computer-implemented method of providing an interface between a user and a processing unit, the method comprising: presenting one or more stimuli to a user, each stimulus varying at a respective stimulation frequency, each stimulation frequency being associated with a respective user-selectable input; receiving at least one signal indicative of brain activity of the user; and determining, from the received signal, which of the one or more stimuli the user attends to and selecting the user-selectable input associated with the stimulation frequency of the determined stimuli as being a user-selected input.

### TECHNICAL FIELD

Disclosed herein are embodiments of a method and an apparatus for providing an interface between a user and a processing unit. In particular, disclosed herein are a method, apparatus and products for providing an interface between a brain and a processing unit including generating stimuli and detecting one or more signals indicative of brain activity.

### BACKGROUND

Locked-in syndrome is a condition in which a person becomes unable to move or talk. While being unable to communicate through usual means, persons suffering from locked-in syndrome are still aware of the surroundings, and can typically move their eyes. To allow such a person to communicate without much help from others, a brain-computer interface (BCI) is a viable option. A BCI is a system comprising a processing unit that acquires and processes signals indicative of brain activity, such as electroencephalographic (EEG) signals, from the user's brain and transforms them into commands to control the processing unit and/or another external (electronic) device. While particularly useful for users suffering from locked-in syndrome it will be appreciated that brain-computer interfaces may also be useful for other types of users such as users suffering from other serious conditions or even healthy users, e.g. users desiring to use their hands for tasks other than operating a computer or other device and/or in situations where voice-based interfaces are not desirable or feasible.

Generally, BCIs may be used to allow users to make a selection from a number of selectable choices such as menus, lists, operational settings of an apparatus, etc. and/or to enter text or other data into a system. In all such systems the user provides information to the system, e.g. information about which selection has been made, the data entered and/or the like. Consequently, an important performance measure of BCIs is the information transfer rate (ITR) which expresses the amount of information users typically convey to the system per unit time. In embodiments, where a user enters text or other characters into the system, the average amount of characters entered per minute (CPM) is another, related performance measure. It is generally desirable to provide methods that provide a high information transfer rate.

### SUMMARY

According to one aspect, disclosed herein are embodiments of a computer-implemented method of providing an interface between a user and a processing unit, the method comprising:
presenting one or more stimuli to a user, each stimulus varying at a respective stimulation frequency, each stimulation frequency being associated with a respective user-selectable input;
receiving at least one signal indicative of brain activity of the user; and
determining, from the received signal, which of the one or more stimuli the user attends to and selecting the user-selectable input associated with the stimulation frequency of the determined stimulus as being a user-selected input; wherein determining comprises:
   a) sampling the received signal over an initial sampling period to obtain an initial sampled signal;
   b) processing the initial sampled signal to detect a dominant one of the stimulating frequencies in the received signal and determining an associated confidence measure;
   c) responsive to detecting a dominant stimulation frequency and subject to the determined associated confidence measure being above a predetermined detection threshold, determining the input associated with the detected dominant stimulation frequency as being a user-selected input; otherwise
   d) responsive to the determined associated confidence measure being below the predetermined detection threshold, continuing sampling the received signal over an extended sampling period, longer than and including the initial period, to obtain an extended sampled signal; and repeating steps b) and c) based on the extended sampled signal.

The inventors have realized that in many situations a relatively short sampling period is sufficient for the system to reliably detect the dominant stimulation frequency in the received signal. In some instances, however, the received signal may be too noisy or otherwise insufficient for a reliable detection of a dominant stimulation frequency. In such situations, a longer sampling period may be required. However, a generally longer sampling period reduces the ITR. The inventors have realized that the ITR of a BCI may significantly be increased when the system uses a short sampling period and, only if a given input cannot reliably be detected after the initial, short sampling period, another detection attempt is made based on an extended sampling period. When the extended sampling period includes the initial sampling period, the additional time required for performing the second detection attempt is reduced.

The duration of the initial sampling period and/or the confidence threshold may depend on the sensor system used for obtaining the received signal as different systems may result in more or less noisy signals. In some embodiments, the length of the initial sampling period may be between 0.5 s and 4 s, e.g. between 1 s and 3 s, such as 2 s. The extended sampling period may have a length being a factor 1.5 and 3 longer than the initial sampling period. For example, the extended sampling period may be obtained by concatenating two sampling periods of the same length, e.g. the initial period and an additional period, thus resulting in an extended sampling period twice as long as the initial period. It will further be appreciated that if, after the first extension of the sampling period, the method still cannot detect a dominant stimulation frequency with sufficient confidence, the above steps may be repeated using further extended sampling periods. It will be appreciated that, in subsequent iterations a decision does not have to be based exclusively on the extended sampling period. For example, some embodiments of the method may analyze both the most recent sampling period and the extended sampling period. If at least one of the periods allow a detection of a dominant frequency with a sufficiently high confidence level, the corresponding input may be selected.

In some embodiments, the method further comprises performing steps b) through d) with increasingly longer sampling periods, each subsequent sampling period including the previous sampling period, so as to detect a plurality of respective dominant stimulation frequencies until a dominant stimulation frequency has been detected with an associated confidence measure above a predetermined detection threshold; and, if after a predetermined number of times none of the detected dominant frequencies has been detected with an associated confidence measure being above the predetermined detection threshold, implementing a voting decision among the detected dominant stimulation frequencies to determine a most likely dominant stimulation frequency, and determining the input associated with the determined most likely dominant stimulation frequency as being a user-selected input.

Consequently, in situations where the process cannot detect a dominant stimulation frequency with sufficient confidence even after repeated extension of the sampling period, some embodiments of the method disclosed herein reach a decision anyway. In particular, after a predetermined number of failed attempts to detect a dominant stimulation frequency based on increasingly long sampling periods, the method performs a voting decision. To this end, the system selects one of the dominant stimulation frequencies that have been detected with below-threshold confidence levels during the repeated attempts as the most likely dominant stimulation frequency. It has turned out that this method succeeds in selecting the input that was intended by the user in sufficiently many situations to provide an overall increase of the ITR.

It will be appreciated that the decision as to which of the detected dominant stimulation frequencies to select may be based on any of a variety of selection criteria and voting mechanisms. A particularly efficiently implementable mechanism is a simple consensus vote, i.e. a selection of a dominant stimulation frequency if said frequency has been selected during at least a predetermined number of consecutive attempts. This mechanism, apart from its ease of implementation, has been found to be surprisingly robust and reliable. Even after a small number of detection attempts, e.g. after 2, 3 or 4 attempts, a reliable detection of the correct stimulation frequency is achieved.

Another voting mechanism uses a majority vote, i.e. a selection of a dominant stimulation frequency that has been detected the largest number of times during the repeated attempts. In one embodiment, the process performs the above majority vote after three unsuccessful attempts with an initial sampling period, an extended sampling period and a twice extended sampling period, respectively. In alternative voting schemes, the different detected dominant stimulation frequencies may be given different weights in the voting scheme, e.g. based on their respective confidence measure and/or based on the length of the respective sampling period.

Different embodiments may use different confidence measures. A particularly efficient and reliable confidence measure is a magnitude of a detected dominant peak in a spectral frequency distribution of the received signal, e.g. an absolute magnitude or a relative magnitude, e.g. a ratio between the largest and second largest peaks. The magnitude may be the height of the peak at a stimulation frequency, the area under the spectral frequency distribution in a predetermined window around the stimulation frequency and/or another suitable measure of the strength of the signal at the dominant frequency. The confidence threshold may be selected based on experimental data with one or a number of users. While the confidence threshold may be individually set for each user, the inventors have found that embodiments of the present method provide good performance even for settings of the confidence threshold that are not user-specific. In some embodiments, the confidence threshold may be adaptively modified during use of the system. For example, in many situations, e.g. in case of character input, a user will normally immediately correct an incorrect detection by the system of the actual character input that was intended by the user, namely by deleting the incorrectly entered character and by replacing it with the intended one. While erroneous inputs may have other reasons than an incorrect determination by the BCI, the frequency of user-corrected inputs may still be used as an estimate of the reliability of the interface. Accordingly, the system may incrementally adapt the confidence threshold during use of the system so as to decrease the detected number of corrections made by the user. For example, a high occurrence of corrections made by the user after determinations by the system based on the initial sample period may be an indication that the confidence threshold is set too low.

Generally, the stimuli may be visual stimuli and the received signal may be indicative of a steady-state visual evoked potential. Attending to a stimulus may thus comprise looking at or even focusing on the visual stimulus.

According to another aspect, disclosed herein are embodiments of a computer-implemented method of providing an interface between a user and a processing unit, the method comprising:
presenting one or more stimuli to a user, each stimulus varying at a respective stimulation frequency, each stimulation frequency being associated with a respective user-selectable input;
receiving at least one signal indicative of brain activity of the user; and
determining, from the received signal, which of the one or more stimuli the user attends to and selecting the user-selectable input associated with the stimulation frequency of the determined stimulus as being a user-selected input;
   wherein presenting comprises:
providing a display area and displaying, in said display area, a first and a second set of representations of respective user-selectable inputs, wherein the first and second sets each comprise a mode selector input;
selectively either presenting respective visual stimuli only associated with each of the first set of representations so as to allow a user to only select one of the user-selectable inputs associated with a representation of the first set, or presenting respective visual stimuli only associated with each of the second set of representations so as to allow a user to only select one of the user-selectable inputs associated with a representation of the second set;
responsive to a determination that the user attends to the mode selector input, switching between presenting stimuli only associated with one of the sets to presenting stimuli only associated with the other one of the sets.

The representations of user-selectable inputs may e.g. be icons, menu items, input characters, etc. The visual stimuli may be a flickering area displayed in close proximity of the representation of the input, e.g. a frame surrounding the representation a geometrical shape next to the representation or a part of or even the entire representation of the input itself. Generally, a periodically varying visual stimulus may be a flickering area that changes brightness and/or colour and/or shape at a predetermined rate. Stimuli associated with different inputs vary at different rates. For example each area may vary at a rate between 5 Hz and 15 Hz, such as between 6 Hz and 12 Hz. Different stimuli may vary at frequencies that differ by at least 0.2 Hz such as at least by 0.5 Hz.

Hence, in embodiments of the method disclosed herein, at least two sets of selectable inputs are displayed within the display area at the same time. It will be appreciated that, in some embodiments, one or more inputs may be included in more than one set, i.e. in some embodiments the intersection of two sets is not empty. Similarly, it will be appreciated that at least one input included in one of the at least two sets is not included in another of the at least two sets of inputs (i.e. the relative complement of one set in the other set is not empty).

Responsive to a determination that the user attends to the mode selector input, the process switches between presenting only stimuli that are associated with one of the sets to presenting only stimuli that are associated with the other one of the sets. Accordingly, only the inputs of a first one of the sets of inputs are provided with respective stimuli while the inputs not included in the first set are displayed without stimuli. In particular, the inputs of the other set of inputs are displayed without stimuli unless they are also included in the first set. A mode selector input is displayed together with an associated stimulus regardless of which of the two sets of inputs is currently displayed together with respective stimuli. To this end, both sets may include and share a common mode selector input, i.e. the mode selector input may be an input that is included in each set. In some embodiments, the mode selector may be the only input which is common to both or all sets of inputs, while all other inputs may be included in a single set of inputs only (i.e. in some embodiments the intersection of two sets includes only a mode selector input). When the system detects that the user attends to the mode selector input (by detecting, as a dominant stimulation frequency in the received signal, the stimulation frequency of the stimulus associated with the mode selector input) the system removes or otherwise disables the stimuli from the set of inputs that are currently displayed with stimuli, and adds or otherwise enables stimuli to the inputs of the other set. Again, it will be understood that, if one or more inputs are included in both sets, their respective stimuli will be enabled both before and after activation of the mode selector input.

Hence, a large number of selectable inputs may be displayed at any given time within the display window while limiting the number of simultaneously displayed visual stimuli. The more visual stimuli are simultaneously presented to the user, the larger the performance requirements imposed on the system in terms of the ability of the system to detect a dominant frequency among the possible stimulation frequencies. Moreover, an increase in the number of different, simultaneously displayed stimuli has been found to be unpleasant and tiring for users. Nevertheless, as the user is presented with a larger number of selectable inputs, the user may more easily plan a sequence of inputs. When the user wishes to select an input of the set that is currently not provided with stimuli, the user attends to the mode selector input, thus causing the system to present stimuli with the other set of inputs, thereby allowing the user to make a selection from said other set of inputs.

In some embodiments, displaying the first and second sets of representations comprises displaying each representation at an associated display position, and wherein switching comprises continuing displaying both sets of representations wherein each representation maintains its display position within the display area. Hence, the display locations of the respective representations of the various inputs do not change during the switching of stimuli between the sets. Consequently, after the stimuli have been switched from one set to the other, e.g. responsive to the user having selected the mode selector input, the representations are still displayed at the same locations as before the switch, thus allowing the user to quickly and efficiently find the desired input to attend to.

As mentioned above, in some embodiment, the intersection between the sets of inputs only includes the mode selector input, i.e. the inputs may be regarded as arranged in two disjoint sets of inputs and a common mode selector. In some embodiments, the display area comprises first, second and third non-overlapping subareas; wherein the representations of the first set, other than a representation of a common mode selector input, are displayed in the first subarea, the representations of the second set, other than a representation of the common mode selector input, are displayed in the second subarea, and the representation of the common mode selector input is displayed in the third subarea. Hence, the respective sets of representations are displayed in separate areas of the display area, thus allowing the user to efficiently select desired inputs. In some embodiments, the first and second subareas may be separated by the third subarea. For example, the first subarea may be positioned on a left side of the display area, the second subarea may be located on a right side of the display area, and the third subarea may be located in a central portion of the display area, separating the first and second subareas from each other. Similarly, the display area may be divided in a vertical fashion into a top, central and bottom subarea; or in a centric fashion into a central, intermediate and outer subarea.

The received signals may be indicative of steady state visual evoked potentials or other suitable signals indicative of brain activity of the user allowing the detection of which stimulus the user attends to.

In certain embodiments, e.g. in a text or character input mode, inputs are made as a sequence of individual inputs, e.g. a sequence of letters, such that, once a sequence is completed, the completed sequence represents a certain input, e.g. a word. Other examples of this type of inputs include the selection of items from a hierarchy of selectable items: The selection of an item on a higher level of the hierarchy determines which items on the next, lower level are selectable. One example of this type of selection may be an address, where the user initially selects a country, then a city within that country, then a street within that city and, finally a number within that street. All these examples of sequential or hierarchical inputs have in common that one or more possible intended complete sequences may be predicted based on a partial sequence already entered by the user. Accordingly, in some embodiments, each of the second set of representations represents at least one selectable sequence of individual inputs; wherein the first set of representations each represents at least one of said individual inputs; and wherein the method comprises: predicting a set of complete sequences, each consistent with a received partial sequence of individual inputs; and including the predicted complete sequences in the second set of representations.

Accordingly, an efficient method is provided for inputting text and other types of input that allow for a prediction of the intended input based on partial inputs.

The features of embodiments of the methods described herein may be implemented in software and carried out on a signal or data processing system or other data and/or signal processing device, caused by the execution of computer-executable instructions. The instructions may be program code means loaded in a memory, such as a Random Access Memory (RAM), from a storage medium or from another computer via a computer network. Alternatively, the described features may be implemented by hardwired circuitry instead of software or in combination with software.

Disclosed herein are different aspects including the methods described above and in the following, corresponding systems, apparatus, and/or products, each yielding one or more of the benefits and advantages described in connection with the first mentioned aspects, and each having one or more embodiments corresponding to the embodiments described in connection with the first mentioned aspects and/or disclosed in the appended claims.

In particular, according to one aspect, disclosed herein are embodiments of a data processing system configured to perform the steps of an embodiment of a method described herein. The signal or data processing system may be a suitably programmed data processing apparatus, e.g. a suitably programmed computer, or a suitably programmed or otherwise configured apparatus for receiving and processing user-selectable inputs.

The processing unit may be any circuitry or device configured to perform data processing, e.g. a suitably programmed microprocessor, a CPU of a computer, of an apparatus operable to receive user inputs, or of another processing device, a dedicated hardware circuit, etc., or a combination of the above. The processing unit may comprise or be communicatively coupled to a memory or other suitable storage medium having computer program code stored thereon adapted to cause, when executed by the processing unit, the processing unit to perform the steps of embodiments a method described herein. The data processing system may comprise a single data processing apparatus such as a stand-alone computer or a plurality of data processing apparatus in data communication connection with each other, e.g. different computers of a computer network.

In some embodiments, the data processing system comprises at least one interface for receiving one or more signals indicative of a user's brain activity; and at least one output interface for presenting stimuli to the users.

The input interface for receiving one or more signals indicative of a user's brain may be any circuitry or device for receiving analogue and/or digital sensor signals. For example, the input interface may comprise a data acquisition circuit for receiving and processing analogue sensor signals from a sensor operable to measure brain activity. To this end the data acquisition circuitry may comprise one or more devices for processing analogue sensor signals, e.g. a pre-amplifier, a filter, an analogue-to-digital converter and/or the like. Alternatively, the input interface may receive processed signals, e.g. in pre-amplified and/or filtered and/or digital form, from a sensor that includes one or more signal processing capabilities. The sensor may e.g. be an apparatus for measuring EEG, e.g. comprising one or more electrodes attached to predetermined positions along the user's scalp. In some embodiments, the data processing system comprises the sensor.

The output interface may e.g. be a display or screen or another device or circuitry for presenting visual representations and visual stimuli to a user. However, it will be appreciated, that in some embodiments of at least some aspects described herein, stimuli other than visual stimuli may be used, e.g. audible stimuli.

According to yet another aspect, disclosed herein are embodiments of a computer program comprising program code configured to cause a data processing system to perform the steps a method disclosed herein, when the program code is executed by the data processing system. The computer program may be embodied as a computer readable medium having stored thereon a computer program. Examples of a computer readable medium include a magnetic storage medium, a solid state storage medium, an optical storage medium or a storage medium employing any other suitable data storage technology. In particular, examples of storage media include a hard disk, a CD Rom or other optical disk, an EPROM, EEPROM, memory stick, smart card, etc.

### BRIEF DESCRIPTION OF THE DRAWINGS

The above and/or additional objects, features and advantages of embodiments of the methods, systems and devices disclosed herein, will be further elucidated by the following illustrative and non-limiting detailed description of embodiments of the methods, systems and devices disclosed herein, with reference to the appended drawings, wherein:

FIG. 1 schematically illustrates an embodiment of a data processing system as described herein.

FIG. 2 schematically illustrates an embodiment of a display area of a data processing system as described herein

FIG. 3 shows a flow diagram of an embodiment of a method for providing an interface between a user and a processing unit.

FIG. 4 illustrates an example of a frequency distribution of a received signal and a resulting detection of a stimulation frequency.

### DETAILED DESCRIPTION

In the following description, reference is made to the accompanying figures, which show by way of illustration how embodiments of the methods, systems and devices disclosed herein may be practiced.

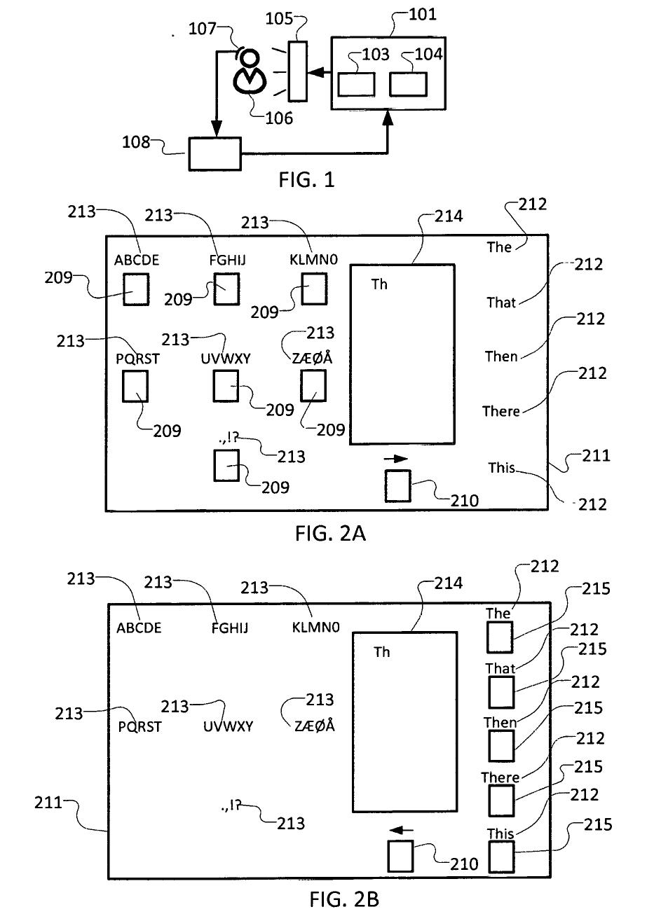

FIG. 1 schematically illustrates an embodiment of a data processing system as described herein. The system comprises a computer 101 or other processing apparatus, a display 105 connected to the computer 101, a data acquisition module 108 connected to the computer, and on or more sensors 107 connected to the data acquisition module 108. Even though the above entities are shown as separate blocks, it will be appreciated that some or all of these devices may be integrated into a single device. For example, the display 105 and/or the data acquisition module 108 may be integrated into the computer 101.

The data acquisition module 108 comprises interface circuitry, e.g. a data acquisition board or other suitable circuitry, for receiving and, optionally, processing detector signals from sensor(s) 107. To this end, the data acquisition module may comprise one or more of the following: an amplifier circuit, one or more suitable filters such as a band pass filter, and an analogue-to-digital converter.

The computer comprises a processing unit 103, e.g. a CPU, suitably programmed or otherwise configured to perform steps of a method described herein. The computer 101 further comprises a memory 104 or other storage medium for storing computer programs and/or data, e.g. previously sampled signals and results of previous detection attempts.

The display 105 may be a computer screen or another type of display configured to present a display area, e.g. as described below.

The sensor 107 may be one or more electrodes attachable at predetermined positions along the scalp of the user 106. In one embodiment the sensor comprises three electrodes, e.g. gold plated electrodes. The electrodes are placed along the user's scalp using locations from the international 10-20 system for electrode placement. For example, the ground electrode is placed at F_{PZ}, reference electrode at F_{Z} and a signal electrode at O_{Z}.

FIG. 2 schematically illustrates an embodiment of a display area of a data processing system allowing a user to enter text. The display area 211 is generally divided into a left portion, a central portion and a right portion. The left portion comprises representations 213 of respective groups of letters and other characters. Selection by the user of one of the groups may cause the data processing system to replace the representations of the groups to display representations of the individual letters/characters of the selected group. Hence, the user may select letters in a two-stage selection by first selecting a group and then selecting a letter/character of the selected group. The right portion of the display area 211 comprises representations 212 of words that are consistent with the previously entered letters. The left and right portions are separated by a central portion that comprises a text box 214 and a mode selector 210.

The left portion of the display area further comprises flickering target areas 209, each in close proximity with one of the representations 213. In the example of FIG. 2A, the target areas 209 are rectangular areas and positioned below the corresponding representation which they are associated with. However, in alternative embodiments, the target areas may have a different shape and/or size and/or they may be positioned in a different manner relative to their respective associated representation.

Each target area flickers at a predetermined rate, such that different target areas flicker at different stimulation frequencies. When the user attends to one of the target areas by looking at and focusing on said target area, the stimulation frequency of said target area may be detected in the EEG signal detected by sensor 107. Consequently, the computer may determine, based on the signal received from the sensor via data acquisition module 108, which of the target areas the user attends to and, thus, which of the input representations 213 the user intends to select. When the user selects one of the groups of letters/characters 213, the corresponding area 209 and/or associated representation may briefly change appearance, e.g. color, so as to indicate the registered selection to the user. Furthermore, upon detection of a user input, the left representations of groups of letters/characters will be replaced by representations of individual letters/characters of the selected group, each letter being associated by a corresponding flickering target area in as similar fashion as shown for the groups of letters/characters in FIG. 2A. Consequently, the user may now select an individual letter or other character. Upon detection of such a selection, the selected letter/character will be appended to any previously entered letters or characters in the in the text box 214. Moreover, the left part of the display area returns to the display of groups of letters/characters as shown in FIG. 2A. It will be appreciated that many variations of the input of individual letters may be possible. For example, other embodiments may use a different grouping of letters/characters and/or a different arrangement of the groups on the display area. Alternatively or additionally, different mechanisms for selecting individual letters/characters while displaying relatively few flickering target areas at the same time may be employed.

In any event, when the user has selected a new letter, the computer determines which words are consistent with the previously entered sequence of letters. In the example of FIG. 2A, the user has entered “Th” and the computer has determined the words “The”, “That”, “Then”, “There” and “This” as most likely continuations. The skilled person will appreciate that there are a number of algorithms for predicting possible intended words based on received sequences of letters. Such algorithms may further base a selection of words on the frequency of occurrence of the words in a given language. They may even take previously entered words into account and/or possible typing errors. It will be appreciated that any suitable spelling algorithm known as such in the art may be implemented in the context of the present user interface. The computer displays representations 212 of a number of determined words consistent with the previously entered letters in the right part of the display area, thus allowing the user to determine whether the actually intended word is among those displayed. When the computer operates the display area 211 in letter-entry mode, i.e. with flickering target areas 209 displayed associated with representations 213 of groups of letters/characters or individual letters/characters, the word proposals 212 are displayed without flickering target areas associated with them, thus reducing the number of flickering target areas displayed at the same time.

To allow selection of the proposed words, the computer displays a mode selector target area 210 which also flickers at a predetermined stimulation frequency different from the frequencies of the other target areas 209. When the computer detects that the user attends to the mode selector area 210, the computer stops displaying flickering areas 209 and instead displays flickering areas 215 associated with the respective word proposals 212, e.g. as shown in FIG. 2B. The flickering target areas 215 flicker at respective stimulation frequencies different from each other. The frequencies of target areas 215 may be different from or equal to the frequencies of the target areas 209, as areas 209 are not displayed at the same time as areas 215. Hence, after selection of mode selector 210, the user may attend to one of the target areas 215 so as to select the corresponding associated word proposal 212. Upon selection of one of the words 212, the partial sequence of letters in text box 214 is replaced by the selected word, optionally including an appended space.

Responsive to the selection of a word, the display may automatically change mode back to the letter-entry mode as shown in FIG. 2A, thus allowing the user to enter a new word. Alternatively or additionally, the user may again attend to mode selector 201 which is shown in both the letter-entry mode of FIG. 2A and the word-entry mode so as to allow the user to toggle back and forth between both modes.

Hence, in the above example, the user interface comprises two areas with flickering targets 209 and 215, respectively, split by a textbox 214. Only one side is flickering at any given time. Below the textbox is another, always-active flickering target 210, the switch or mode-selector target, which is responsible for switching between the flickering sides as illustrated in FIG. 2A-B.

The seven targets on the left side of the textbox represent a two-stage model for selecting individual characters. In the first stage, the user selects a subgroup 213 of characters, and in the second stage, the user selects the desired character. The right side represents a dictionary with five different word targets 212. Each target represents a different word, and all words are updated whenever a character is written or deleted. Even though the example shown in FIG. 2A-B shows letters corresponding to the Danish alphabet, the system may support dictionaries in multiple languages. Likewise, it will be appreciated that other alphabets may be represented in a similar fashion.

At any given time, there are either eight or six active flickering targets including the switch target 210. In one embodiment the sizes of the target areas and the distance between adjacent target areas is selected such that each target approximately covers the fovea when viewed from a normal viewing distance and such fovea can only cover one target.

When a target is selected, it changes appearance, e.g. color for a brief moment, to let the user know which target is recognized. This reduces how often the user switches gaze between the textbox and individual targets. If the selected target is a word from the dictionary, a space character is added after the word, and flickering is switched back to individual characters.

It will be appreciated that the display area of FIGS. 2A-B may also be used to allow a user to enter other types of information different from texts.

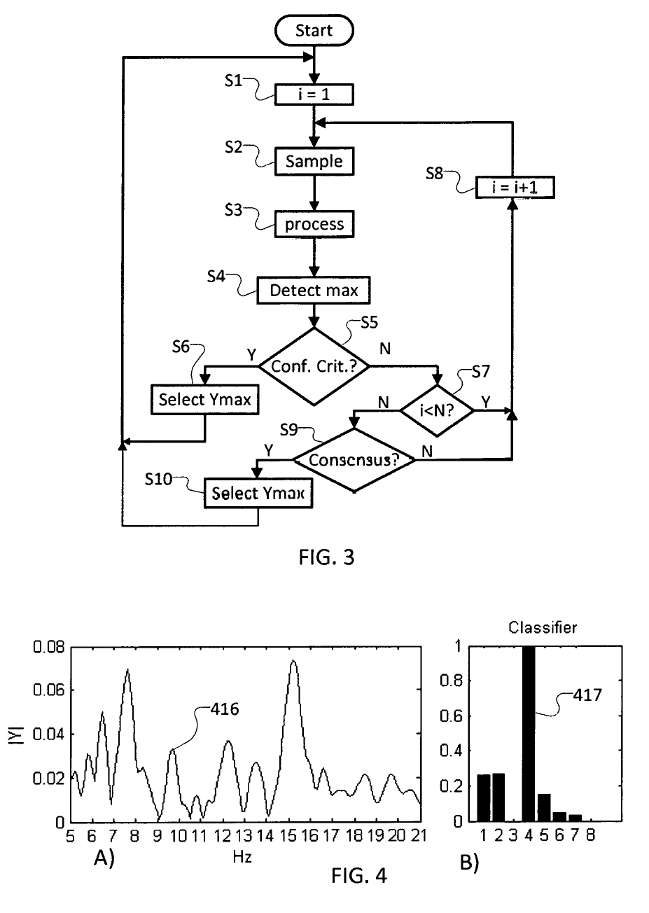

FIG. 3 shows a flow diagram of an embodiment of a method for providing an interface between a user and a processing unit. For example, the process may be performed by the computer 101 of FIG. 1. In initial step S1, the process initializes a counter i so as to count the number of attempts made for detecting which flickering target area of a display, e.g. the display of FIG. 2A-B, the user looks at. In the subsequent steps S2 through S10, the process iteratively performs attempts to detect which flickering target area the user attends to. In an initial iteration (i=1) the detection is based on a received signal sampled over an initial sample period. In subsequent iterations (i>1) the detection is based on a new sampling period as well as on data from a concatenation of all previous sampling periods. Moreover, after at least N (e.g. N=2, 3, 4 or a larger number) failed iterations, the detection is further based on a consensus vote among all previous attempts.

In particular, in step S2, the process receives the EEG signal from the data acquisition module 108 and samples the signal over the most recent sampling period, e.g. 2 s, at a predetermined sampling rate. In the initial iteration (i=1), the most recent sampling period is the initial sampling period. The sampling rate is selected sufficiently high so as to allow detection of the stimulation frequencies and, optionally, one or more higher harmonics of the stimulation frequency, in the signal. Optionally, further signal processing such as autocorrelation may be applied to the sampled data, so as to reduce noise. The result of the sampling step is a data set SData representing the sampled data of a single sampling period, namely the most recent sampling period. In subsequent iterations (i>1), the process further creates a concatenated data set CData representing a concatenation of up to a predetermined number of (e.g. three) most recent sets of SData.

At subsequent step S3, the process processes the sampled data SData and, if i>1, also CData, so as to obtain a frequency distribution of the sampled signal in SData and, if i>1, a frequency distribution of the concatenated signal in CData. To this end, the process may apply Fast Fourier Transform to obtain a frequency distribution(s) at a sufficiently high resolution e.g. below 0.5 Hz such as 0.1 Hz. FIG. 4A shows an example of a thus obtained frequency distribution obtained from a 2 s sampling period. In particular curve 416 shows the power amplitudes |Y| of the signal as a function of frequency.

In step S4, the process detects the dominant stimulation frequency from the frequency distribution of SData and, if i>1, also a dominant stimulation frequency of CData. As the process knows the stimulation frequencies used for the respective target areas, the process may calculate a predetermined classification measure for each of the known stimulation frequencies in each data set.

For example, for each stimulation frequency the classifier may compute a sum of power amplitudes within a predetermined frequency interval around said frequency. As tests have shown that some users may have a response in the second harmonic of the stimulation frequency which is comparable or even larger than the response at the fundamental harmonic, some embodiments also take the second harmonic (or even higher harmonics) into account when computing the classification measure. For example, FIG. 4A shows an example where the stimulation frequency of the flickering target was 7.5 Hz, and the frequency spectrum shows dominant peaks at H1=7.5 Hz and at H2=15 Hz.

In particular, one embodiment computes the following classification measure:

cₓ=Σ_{H1-0.1}^{H1+0.1}|Y|+Σ_{H2-0.1}^{H2+0.1}|Y|

Here H1 and H2 are the fundamental stimulation frequency and its second harmonic, respectively. In the above example the window size is 0.2 Hz; however, other embodiments may use other window sizes.

The thus computed classification values may then be normalized such that the maximum normalized classification value for each data set is 1. An example of resulting classification values is shown in FIG. 4B. Hence, in each data set, the dominant frequency of the stimulation frequencies is the frequency having a classification value of Cₓₘₐₓ=1.

In step S5, the process determines whether a dominant frequency is detected at a sufficiently high confidence value. In one embodiment, the process considers, for each of the data sets SData and, if i>1, CData, the second largest classification value Cₓ₂ of the computed classification values. If the second largest value in at least one data set is smaller than a predetermined threshold (i.e. the ratio of the largest to the second largest value is larger than a given threshold), the dominant frequency is determined to be reliably detected, and the process proceeds at step S6. Otherwise, the dominant frequency is considered not to be sufficiently reliably detected and the process proceeds at step S7.

The thresholds may be selected to be the same for SData and CData. Alternatively they may be selected to be different. The two thresholds may be determined through empirical testing. Increasing the thresholds can improve selection times for some users but at the same time reduce accuracy for others. For example, in one embodiment, the threshold for the second largest value in SData may be selected to be 0.35 while the threshold for the second largest value in CData may be selected to be 0.45.

At step S6, the process determines the input associated with the detected dominant frequency as the input selected by the user. Depending on the mode of operation of the computer and of the nature of the selected input, the computer processes the determined input. For example, the computer may display a selected character or word in a text box, change the display mode, etc. or combinations thereof. If more inputs are expected, the process returns to step S1 so as to determine the subsequent user input.

At step S7, the process tests whether at least N iterations have been performed without detecting a dominant stimulation frequency with the desired confidence level. If this is not the case, the process increments the counter i (step S8) and returns to step S2 to make another attempt at detecting the input intended by the user. Otherwise, the process proceeds at step S9 to implement a voting scheme.

In particular, at step S9, the process determines whether the detected dominant frequency during the N most recent N iterations was the same, even though none of the detections was made with a sufficiently high confidence value. If such a consensus frequency is not identified the process increments the counter i (step S8) and returns to step S2 to make another attempt at detecting the input intended by the user. Otherwise, the process proceeds at step S10 where the process determines the input associated with the identified consensus frequency as the input selected by the user. If more inputs are expected, the process returns to step S1 so as to determine the subsequent user input.

Hence, in the above example, the selection of a dominant frequency only happens if at least one of the following three confidence tests is satisfied:
1) The second largest classification value in SData is smaller than a first threshold (e.g. <0.35).
2) The second largest classification value in CData is smaller than a second threshold (e.g. <0.45).
3) The same frequency is dominating in N consecutive iterations (e.g. N=4).

It will be appreciated that, instead of the consensus voting scheme of step S8 above, other voting schemes may be implemented, such as a majority or committee vote or a vote where the frequencies detected in respective iterations are weighted by their confidence measure, or another suitable voting scheme.

### Example

The performance of an embodiment of the present method and system has been experimentally verified using a system and detection method as described in connection with FIGS. 1-3. During experiment sessions, only the experimental supervisor and the test subject were sitting in an unshielded room. Inside the room, the lights were off during the experiments and the test subject was seated 60 cm away from the display 105 which in this case was a liquid crystal display (LCD) showing stimuli. The LCD was a BenQ XL2420T 24″ set to a refresh rate of 120 Hz. Contrast and brightness were set to maximum, resulting in a display brightness of 350 cd/m². The resolution was 1680×1050 pixels. Targets presented to the subjects had an area of 2.89 cm². The stimuli application was developed in Microsoft Silverlight and was executed on a Windows 8 PC.

Three gold plated electrodes were placed along the test subject's scalp using locations from the international 10-20 system for electrode placement. The ground electrode is placed at F_{PZ}, reference electrode at F_{Z} and a signal electrode at O_{Z}. Impedances were kept around 5 kΩ or lower. The data acquisition module 108 included a g.USBamp amplifier from g.tec (Guger Technologies) set to a sampling rate of 512 Hz and an analog band-pass filter from 5 Hz to 30 Hz. The system implemented a display area as described in connection with FIG. 2A-B above.

At any given time, there were either eight or six active flickering targets including the switch target 210. Since the size of each target was only 2.89 cm², it barely covered the fovea. The distance between any two targets was at least 1.7 cm in any direction, so that at any point, fovea can only cover one target. The used stimulation frequencies were 6 Hz, 6.5 Hz, 7 Hz, 7.5 Hz, 8.2 Hz, 9.3 Hz, 10 Hz, and 11 Hz. When a target was selected, it turned green for a brief moment, to let the user know which target was recognized. This reduces how often the user switches gaze between the textbox and individual targets. If the selected target is a word from the dictionary, a space character is added after the word, and flickering is switched back to individual characters.

The classifier had two sets of data that are examined in each iteration. The duration of an iteration was approximately two seconds. The data sets are:
SData: Most recent two seconds of EEG.
CData: A concatenation of up to three most recent sets of SData.

After sampling for two seconds, autocorrelation was applied on SData to reduce the noise.

Then FFT was applied on both sets with necessary zero-padding to obtain a frequency resolution of 0.1 Hz. Next, the classes were generated for both sets. Each class represents a target frequency. The value of each class, Cx, was the sum of power amplitudes, |Y|, around the relevant frequencies:

cₓ=Σ_{H1-0.1}^{H1+0.1}|Y|+Σ_{H2-0.1}^{H2+0.1}|Y|,

where H1 is the fundamental frequency presented, and H2 is the second harmonic. The second harmonic was taken into account, because early tests showed, that a person can have a stronger or equal response in the second harmonic as the fundamental frequency. This occurrence appears to be related to the accuracy and precision of stimulus generation. The values in all classes were normalized in respect to each other such that the dominating class has a value of one, but the selection only happened if at least one of three quality tests were satisfied:
The second greatest value in SData<0.35.
The second greatest value in CData<0.45.
The same class is dominating in four consecutive iterations.

The two thresholds were determined through empirical testing.

FIG. 4 shows an example of a successful classification done after two seconds on signal where classification is not immediately evident. Looking only at the fundamental frequencies, 7.5 Hz (class 4) does not appear much larger than 6.5 Hz (class 2). However, when combining the frequencies with their second harmonics, one sees that 13 Hz is not present, causing class 4, the class representing 7.5 Hz, to stand out significantly.

To test the system, each test subject had to write four sentences (three Danish and one English sentence). Question marks and spaces were counted as characters. A sentence was not considered finished until it was correct, so any spelling mistakes along the way had to be corrected. After each sentence, the user took a small break of less than a minute. The four sentences were:

S1: “The quick brown fox jumps over the lazy dog”
S2: “Jeg vil gerne se en film”
S3: “Hvad har du lavet I dag?”
S4: “Zebraen [symbol] nskede sig sæspa\dot{a}ner”

Nine healthy subjects participated and successfully wrote all four sentences. Six males and three females, age 26.8±5. Only one test subject was familiar with the concepts of BCI systems. TABLE I. shows the total amount of selections required to write all four sentences, the average time a selection takes, and the accuracies throughout all selections.

TABLE 1
Performance of individual test subjects.

| | Total | Avg. Selection | Accuracy |
|---|---|---|---|
| Subject | Selections | time (s) | (%) |
| 1 | 206 | 6.71 | 94.08 |
| 2 | 222 | 6.32 | 92.11 |
| 3 | 196 | 6.58 | 92.27 |
| 4 | 173 | 5.28 | 97.13 |
| 5 | 270 | 7.27 | 88.83 |
| 6 | 285 | 8.12 | 86.54 |
| 7 | 238 | 5.48 | 92.02 |
| 8 | 304 | 8.04 | 83.27 |
| 9 | 260 | 5.79 | 91.09 |
| Mean ± | 239.33 ± 43.77 | 6.62 ± 1.03 | 90.81 ± 4.11 |
| std | | | |

The time it took to write a sentence was significantly lower when the subject used the dictionary. As an example, the two subjects (4 and 7) who were fastest at selecting times had very different approaches. Subject 4 was very aware of which words were in the dictionary, while subject 7 paid little attention to it. When questioned, Subject 7 replied that the BCI responded fast enough so dictionary aid was not necessary.

The performance of BCI Systems is usually evaluated based on the information transfer rate (ITR) expressed as bits/min. ITR is derived from the time it takes to perform a task, accuracy of the system and the amount different tasks that can be performed. The lowest and highest achieved ITR in the present experiment were 11.58 bits/min and 37.57 bits/min, respectively. It is interesting to note that the individual performance did not vary much, showing the robustness of the system.

Although some embodiments have been described and shown in detail, the aspects disclosed herein are not restricted to them, but may also be embodied in other ways within the scope of the subject matter defined in the following claims. In particular, it is to be understood that other embodiments may be utilized and structural and functional modifications may be made.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A computer-implemented method of providing an interface between a user and a processing unit, the method comprising:
presenting one or more stimuli to a user, each stimulus varying at a respective stimulation frequency, each stimulation frequency being associated with a respective user-selectable input;
receiving at least one signal indicative of brain activity of the user; and
determining, from the received signal, which of the one or more stimuli the user attends to and selecting the user-selectable input associated with the stimulation frequency of the determined stimulus as being a user-selected input;
wherein presenting comprises:
providing a display area and displaying in said display area a first and a second set of representations of respective user-selectable inputs wherein the first and second sets each comprise a representation associated with a mode selector input;
selectively either presenting respective visual stimuli associated with each of the first set of representations so as to allow a user to only select one of the user-selectable inputs associated with a representation of the first set, or presenting respective visual stimuli associated with each of the second set of representations so as to allow a user to only select one of the user-selectable inputs associated with a representation of the second set;
responsive to a determination that the user attends to the mode selector input switching between presenting only stimuli associated with one of the sets to presenting only stimuli associated with the other one of the sets.

2. A method according to claim 1; wherein displaying the first and second sets of representations comprises displaying each representation at an associated display position, and wherein switching comprises continuing displaying both sets of representations wherein each representation maintains its display position within the display area.

3. A method according to claim 1; wherein each of the second set of representations represents at least one selectable sequence of individual inputs; wherein the first set of representations each represents at least one of said individual inputs; and wherein the method comprises: predicting a set of complete sequences, each consistent with a received partial sequence of individual inputs; and including the predicted complete sequences in the second set of representations.

4. A method according to claim 1, wherein the display area comprises first, second and third non-overlapping subareas; wherein the representations of the first set other than a representation of a common mode selector input are displayed in the first subarea, the representations of the second set other than a representation of the common mode selector input are displayed in the second subarea, and the representation of the common mode selector input is displayed in the third subarea.

5. A method according to claim 1, wherein determining comprises:
a) sampling the received signal over an initial sampling period to obtain an initial sampled signal;
b) processing the initial sampled signal to detect a dominant one of the stimulating frequencies in the received signal and determining an associated confidence measure;
c) responsive to detecting a dominant stimulation frequency and subject to the determined associated confidence measure being above a predetermined detection threshold, determining the input associated with the detected dominant stimulation frequency as being a user-selected input; otherwise
d) responsive to the determined associated confidence measure being below the predetermined detection threshold, continuing sampling the received signal over an extended sampling period, longer than and including the initial period, to obtain an extended sampled signal; and repeating steps b) and c) based on the extended sampled signal.

6. A computer-implemented method of providing an interface between a user and a processing unit, the method comprising:
presenting one or more stimuli to a user, each stimulus varying at a respective stimulation frequency, each stimulation frequency being associated with a respective user-selectable input;
receiving at least one signal indicative of brain activity of the user; and
determining, from the received signal, which of the one or more stimuli the user attends to and selecting the user-selectable input associated with the stimulation frequency of the determined stimulus as being a user-selected input; wherein determining comprises:
e) sampling the received signal over an initial sampling period to obtain an initial sampled signal;
f) processing the initial sampled signal to detect a dominant one of the stimulating frequencies in the received signal and determining an associated confidence measure;
g) responsive to detecting a dominant stimulation frequency and subject to the determined associated confidence measure being above a predetermined detection threshold, determining the input associated with the detected dominant stimulation frequency as being a user-selected input; otherwise
h) responsive to the determined associated confidence measure being below the predetermined detection threshold, continuing sampling the received signal over an extended sampling period, longer than and including the initial period, to obtain an extended sampled signal; and repeating steps b) and c) based on the extended sampled signal.

7. A method according to claim 6 further comprising performing steps b) through d) with increasingly longer sampling periods, each subsequent sampling period including the previous sampling period, so as to detect a plurality of respective dominant stimulation frequencies until a dominant stimulation frequency has been detected with an associated confidence measure above a predetermined detection threshold and, if after a predetermined number of times, none of the detected dominant frequencies has been detected with an associated confidence measure being above the predetermined detection threshold, implementing a voting decision among the detected dominant stimulation frequencies to determine a most likely dominant stimulation frequency, and determining the input associated with the determined most likely dominant stimulation frequency as being a user-selected input.

8. A method according to claim 7; wherein the voting decision comprises determining a number of occurrences for each detected dominant stimulation frequency, and selecting the dominant stimulation frequency having a largest number of occurrences among the detected dominant stimulation frequencies to be the most likely dominant stimulation frequency.

9. A method according to claim 8; wherein determining a number of occurrences for each detected dominant stimulation frequency comprises weighting the number of occurrences with the respective associated confidence measures.

10. A method according to claim 6, wherein the confidence measure associated with a dominant stimulation frequency is a magnitude of a detected dominant peak in a spectral frequency distribution of the received signal.

11. A method according to claim 6 wherein the received signals are indicative of steady state visual evoked potentials.

12. A method according to claim 6 wherein each stimulus is a flickering target displayed in a proximity to a representation of the associated user-selectable input.

13. A data processing system comprising: a signal input interface operable to receive a signal indicative of brain activity of a user, a processing unit; and an output interface operable to present a stimuli to the user; wherein the processing unit is configured to perform the steps of a method as defined in any one of the preceding claims.

14. A computer program comprising program code configured to cause a data processing system to perform the steps of the method of claim 1, when the program code is executed by the data processing system.

15. A computer-readable medium having stored thereon a computer program according to claim 14.
